(19) United States
(12) Patent Application Publication
(10) Pub. No.: US 2016/0316392 A1
(43) Pub. Date: Oct. 27, 2016

(54) LTE-WLAN Traffic Offloading Enhancement Using Extended BSS Load Element

(71) Applicant: SPREADTRUM HONG KONG LIMITED, Central (CN)

(72) Inventors: Anna Pantelidou, Oulu (FI); Arto Lehti, Oulu (FI)

(73) Assignee: SPREADTRUM HONG KONG LIMITED, Central (CN)

(21) Appl. No.: 14/710,816

(22) Filed: May 13, 2015

Related U.S. Application Data
(60) Provisional application No. 62/153,218, filed on Apr. 27, 2015.
(60) Provisional application No. 62/153,227, filed on Apr. 27, 2015.
(60) Provisional application No. 62/153,223, filed on Apr. 27, 2015.

(51) Int. Cl. H04W 28/08; H04W 24/10; H04B 7/04; H04B 1/40; H04W 16/14

(52) U.S. Cl. CPC H04W 28/08; H04B 1/40; H04W 16/14; H04B 7/0452; H04W 24/10; H04W 84/12

(57) ABSTRACT

Systems, methods, devices, and computer-program products according to the specification and drawings, whereby an estimate of spectrum utilization or availability to a wireless local area network may be obtained by observing or obtaining a channel utilization related element, such as an Extended BSS load element. Upon determining spectrum utilization or availability, this information is useful for deciding whether or not to offload mobile device traffic from a cellular network to the wireless local area network.

### CROSS-REFERENCES TO RELATED APPLICATIONS

This application claims the benefit of U.S. Provisional Application No. 62/153,218, filed Apr. 27, 2015, entitled LTE-WLAN TRAFFIC OFFLOADING ENHANCEMENT USING EXTENDED BSS LOAD ELEMENT, the entire disclosure of which is hereby incorporated by reference for all purposes. This application claims the benefit of U.S. Provisional Application No. 62/153,227, filed Apr. 27, 2015, entitled INTRODUCING USER CATEGORIZATION IN CHANNEL ACCESS, the entire disclosure of which is hereby incorporated by reference for all purposes. This application claims the benefit of U.S. Provisional Application No. 62/153,223, filed Apr. 27, 2015, entitled QCI USAGE AND SIGNALING FOR IP FLOW SELECTION, the entire disclosure of which is hereby incorporated by reference for all purposes.

### BACKGROUND

As wireless technologies have evolved, a desire for greater wireless bandwidth has increased. For cellular technologies, the evolution from 2G to 3G to 4G has provided increased bandwidth for mobile devices, but these technologies have not kept up with the bandwidth demands of wireless users. Wireless local area networking, such as in compliance with Institute of Electrical and Electronics Engineers (IEEE) 802.11 specifications, has provided higher bandwidth availability, though these technologies have historically found primarily utility in computer networks rather than cellular networks, in part due to the short transmission range of 802.11 wireless signals. However, mobile devices, such as smartphones, available in the marketplace may employ both 802.11 wireless radios as well as 4G cellular radios, such as Long Term Evolution (LTE), Worldwide Interoperability for Microwave Access (WiMAX), and variants thereof, and comparable speed 3G-based technologies, such as Evolved High-Speed Packet Access (HSPA+). These mobile devices are capable of utilizing both the wide area cellular network technology as well as the wireless local area network technology for relieving bandwidth demands, at least in part.

### SUMMARY

The present disclosure is directed to 3GPP (3^{rd} Generation Partnership Project)/non-3GPP interworking. In embodiments, an estimate of a wireless local area network (WLAN) availability may be obtained by using the Extended BSS (Basic Service Set) load feature specified in the IEEE 802.11ac specification, and/or future WLAN specifications, and used as a measure on the performance of the WLAN in order to decide whether to offload network traffic to the WLAN or not. Although not so limited, an appreciation of the various aspects of the present disclosure may be gained from the following discussion in connection with the drawings referred to therein.

In various aspects, the present invention provides systems, devices, methods and computer program products. For example, systems, devices, methods and products are provided for selectively routing mobile device traffic to a wireless local area network (WLAN). Aspects described include offloading mobile device traffic from a cellular wide area network (WAN) and complete handover of a mobile device from a cellular WAN to a WLAN.

In one aspect, devices and system configured to selectively route mobile device traffic to a wireless local area network (WLAN) are provided. For example, such a device optionally comprises a cellular wide area network (WAN) transceiver for communicating with a cellular WAN and a WLAN transceiver for communicating with a WLAN. Such a device or system optionally comprises or optionally further comprises a processor and a memory element coupled with and readable by the processor and having stored therein processor-readable instructions. Optionally, the processor-readable instructions, when executed by the processor, cause the processor to perform one or more methods described herein. For example, the processor-readable instructions, when executed by the processor, optionally cause the processor to perform operations comprising receiving a measurement control message from the cellular WAN, such as a measurement control message that identifies a target WLAN, identifying wireless spectrum utilization for the target WLAN, and determining that traffic of a mobile device is to be routed to the target WLAN based on the identified wireless spectrum utilization.

Optionally, the device comprises a mobile device and the measurement control message is received at a transceiver of the mobile device. Optionally, the device comprises a wireless access point of the target WLAN and the measurement control message is received at a transceiver of the wireless access point.

In another aspect, methods for selectively routing mobile device traffic to a WLAN are provided. For example, such a method optionally comprises receiving a measurement control message from the cellular wide area network (WAN), such as a measurement control message that identifies a target WLAN, identifying wireless spectrum utilization for the target WLAN, and determining that traffic of a mobile device is to be routed to the target WLAN based on the identified wireless spectrum utilization.

In another aspect, computer program products for selectively routing mobile device traffic to a WLAN are provided. Optionally, a computer program product of this aspect comprises a non-transitory computer-readable medium having stored therein processor-readable instructions that, when executed by a processor, cause the processor to perform one or more methods describe herein. For example, the processor-readable instructions, when executed by a processor, optionally cause the processor to perform operations comprising receiving a measurement control message from a cellular WAN, such as a measurement control message that identifies a target WLAN, identifying wireless spectrum utilization for the target WLAN, and determining that traffic of a mobile device is to be routed to the target WLAN based on the identified wireless spectrum utilization.

Various measurement control messages are useful with the devices, systems methods and products. In embodiments, measurement control messages are useful for identifying a target WLAN, for requesting wireless spectrum utilization, for providing threshold levels, etc. In one implementation, the measurement control message includes one or more network identifiers for identifying the target WLAN, such as a BSSID (Basic Service Set Identifier), an SSID (Service Set Identifier), an HESSID (Homogeneous Extended Service Set Identifier), and the like. Optionally, the measurement control message includes a request for wireless spectrum utilization for the target WLAN. For example, the measurement control message may include a request for an Extended BSS load element.

Wireless spectrum utilization may be identified and used by various aspects described herein. For example, wireless spectrum utilization may be useful for determining an availability of a WLAN for handling offloaded mobile device traffic. For example, identifying wireless spectrum utilization for the target WLAN optionally comprises receiving one or more beacon frames from the target WLAN, such as at least one beacon frame that includes an Extended Basic Service Set load element. Optionally, identifying wireless spectrum utilization for the target WLAN comprises: transmitting a request for wireless spectrum utilization parameters to the target WLAN and receiving a response from the target WLAN providing the wireless spectrum utilization parameters. Optionally, the request comprises a wireless probe request, and the response includes an Extended Basic Service Set (Extended BSS) load element or one or more fields of an Extended BSS load element. Optionally, the request comprises a request for WLAN channel utilization.

In various embodiments, identifying wireless spectrum utilization for the target WLAN comprises identifying one or more of a WLAN Multiple User-Multiple Input Multiple Output (MU-MIMO) station count, a WLAN spatial stream underutilization, a WLAN observable primary channel utilization, and a WLAN observable secondary channel utilization.

Determination of the above wireless spectrum utilization parameters may be achieved by various means. For example, identifying wireless spectrum utilization for the target WLAN optionally comprises receiving a measurement report including the wireless spectrum utilization for the target WLAN. Optionally, identifying wireless spectrum utilization for the target WLAN comprises monitoring network communications on one or more wireless channels used by the target WLAN, and computing wireless spectrum utilization based on the monitored network communications.

Upon making a determination that traffic of the mobile device is to be routed to the target WLAN all or a portion of the traffic is routed to the target WLAN. Various techniques may be used for making this determination. For example, determining that traffic of the mobile device is to be routed to the target WLAN optionally comprises transmitting a measurement report to the cellular WAN, such as a measurement report that includes identified wireless spectrum utilization for the target WLAN, and receiving a steering command from the cellular WAN, such as a steering command that indicates that at least a portion of traffic of the mobile device is to be routed to the target WLAN. Optionally, determining that traffic of the mobile device is to be routed to the target WLAN comprises analyzing the identified wireless spectrum utilization, and determining that the target WLAN possesses sufficient capacity for receiving at least a portion of the traffic of the mobile device.

In embodiments, the mobile device may not be associated with the target WLAN. Optionally, determining that traffic of the mobile device is to be routed to the target WLAN comprises transmitting an association request message to the target WLAN and establishing a WLAN connection with the target WLAN.

In various embodiments, threshold levels may be utilized in the determination of whether to offload traffic from a mobile device to a WLAN. For example, threshold levels may be used to identify sufficient availability of a WLAN prior to offloading traffic to the WLAN. Additionally or alternatively, threshold levels may be used to determine when a measurement report is to be transmitted. Additionally or alternatively, threshold levels may be used to determine when a response to a measurement report is to be transmitted. In various embodiments, thresholds for various network characteristics may be identified, such as a primary channel utilization, a secondary channel utilization, a spatial stream underutilization, a station count, and the like.

Optionally, the measurement control message includes a measurement threshold, such as a measurement threshold identifies a target wireless spectrum utilization value sufficient for offloading traffic of the mobile device to the target WLAN. Optionally, determining that traffic of the mobile device is to be routed to the target WLAN comprises comparing the identified wireless spectrum utilization with the measurement threshold and determining that the target WLAN possesses sufficient capacity for receiving at least a portion of the traffic of the mobile device based on the comparison.

In various embodiments, traffic from a mobile device is offloaded to a WLAN. In this way, higher bandwidth and or improved quality of service can be provided, for example, to a user. For example, when sufficient WLAN capacity is available, the WLAN is used instead of the cellular WAN as an alternate route for mobile device traffic.

Optionally, aspects described herein include routing a portion of the traffic of the mobile device to the target WLAN. Optionally, aspects described herein include routing all of the traffic of the mobile device to the target WLAN. Optionally, aspects described herein include handover of the mobile device from the cellular WAN to the target WLAN. Optionally, aspects described herein include negotiating handover of the mobile device from the cellular WAN to the target WLAN. Optionally, routing a portion of the traffic of the mobile device to the target WLAN.

Aspects of the above methods, systems, devices and products can use various wireless networking technologies, including technologies not yet developed and/or standardized but which implement aspects of the invention. In various specific embodiments, the target WLAN comprises an Institute of Electrical and Electronics Engineers (IEEE) 802.11ac compliant WLAN, the measurement control message includes a service set identifier for the target WLAN, and/or the cellular WAN comprises a long-term evolution (LTE) compliant WAN. In a specific embodiment, the disclosed methods, systems, devices and products are useful for selectively routing data traffic to one of a 3GPP (3^{rd} Generation Partnership Project) network and a non-3GPP network. For example, an exemplary 3GPP network is a cellular wide area network and an exemplary non-3GPP network is a wireless local area network.

Further areas of applicability of the present disclosure will become apparent from the detailed description provided hereinafter. It should be understood that the above summary, and the following detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of the present invention may be realized by reference to the remaining portions of the specification, and the drawings, wherein like reference numerals are used throughout to refer to similar components.

FIG. 1 provides an overview of a wireless environment according to various embodiments.

FIG. 2 provides details of the format of an Extended BSS load element in accordance with some embodiments.

FIG. 3 illustrates channel list parameter elements in various embodiments of a wireless local area network.

FIG. 4 illustrates channel list parameter elements in various embodiments of a wireless local area network.

FIG. 5 provides an overview of signal exchange in accordance with some embodiments.

FIG. 6 provides an overview of signal exchange in accordance with some embodiments.

FIG. 7 provides an overview of signal exchange in accordance with some embodiments.

FIG. 8 provides an overview of signal exchange in accordance with some embodiments.

FIG. 9 provides an overview of signal exchange in accordance with some embodiments.

FIG. 10 provides a schematic illustration of a computing device in accordance with some embodiments.

### DETAILED DESCRIPTION

In various embodiments, the systems, methods, devices, and computer program products described herein provide techniques for offloading mobile device traffic from a cellular wide area network to a wireless local area network (WLAN). For example, WLAN utilization may be identified for use in determining when it is appropriate to offload mobile device traffic to a WLAN. In various embodiments, WLAN channel utilization data provides an indication of available WLAN bandwidth, WLAN spectral resources, and other WLAN network capacity measures.

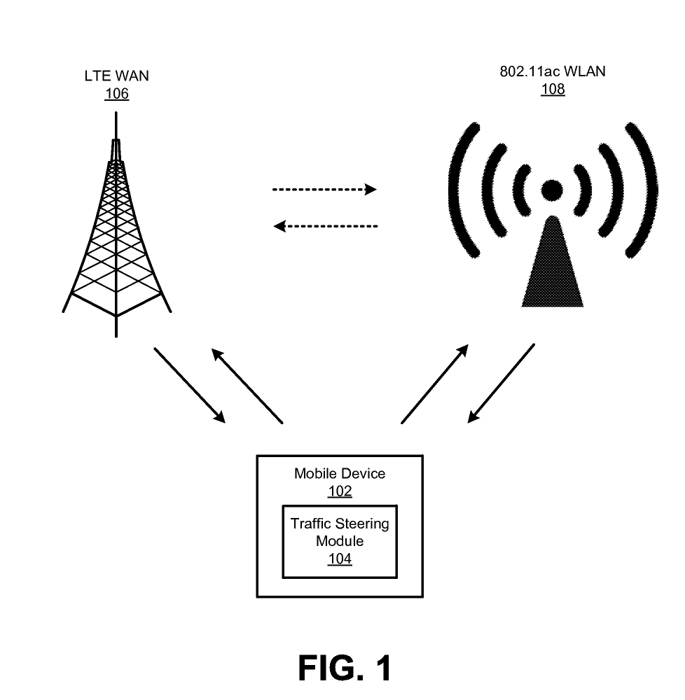

FIG. 1 provides an overview of a wireless environment 100 in accordance with some embodiments. FIG. 1 illustrates a mobile device 102, a cellular WAN 106, and a WLAN access point (AP) 108. As illustrated, cellular WAN 106 is represented as providing wide area network access compliant with a Long Term Evolution (LTE) standard, though other cellular network technologies are contemplated, such as Wideband Code Division Multiple Access (WCDMA) and other cellular wide area network technologies that presently exist or may be developed in the future. WAN 106 may include one or more (enhanced) Node B devices or other cellular base station type devices. As illustrated, WLAN access point 108 is represented as compliant with IEEE 802.11ac, though other WLAN technologies are contemplated, such as those that presently exist or may be developed in the future that incorporate an Extended BSS load element or a characterization of wireless spectrum utilization.

As used herein, the term mobile device may be synonymous with the term User Equipment (UE) as this term is utilized with regards to cellular network technology and station (STA) as this term is utilized with regards to WLAN technology. In embodiments, the term mobile device includes various network devices that implement both cellular wide area network radios and associated antennas and wireless local area network radios and associated antennas. For example, in one embodiment a mobile device is a cell phone. In one embodiment, a mobile device is a smartphone. In some embodiments, a mobile device is a laptop or tablet computer. In some embodiments, a mobile device includes multiple radios and one or more shared antennas. Optionally, the term radio is used synonymously with the term transceiver, and refers to a component for generating and receiving wireless radio frequency or microwave frequency communications, such as digital communications.

Mobile device 102 is shown as being in two-way data communication with WAN 106, such as by way of one or more wireless radios and one or more wireless antennas present in mobile device 102. Mobile device 102 is also shown as being in two-way data communication with WLAN AP 108, such as by way of one or more wireless radios and one or more wireless antennas present in mobile device 102. Optionally, WAN 106 and WLAN AP 108 may be in two-way data communication with one another, such as using one or more wireless radios or using a wired or optical network backhaul, for example.

As will be understood by the skilled artisan, two-way data communication may not necessarily be present at all times between mobile device 102 and both WAN 106 and WLAN AP 108 simultaneously, such as if mobile device is not registered with and/or associated with WAN 106 or WLAN AP 108 at a particular instance. Further, the skilled artisan will appreciate that although mobile device 102 may not be registered with and or associated with WAN 106 or WLAN AP 108 at a particular instance, mobile device 102 may still be able to receive signals broadcast by WAN 106 or WLAN AP 108.

In embodiments, mobile device 102 may include a traffic steering module 104, which may be implemented as a hardware or software component of mobile device 102. Traffic steering module, optionally is useful for selectively directing traffic from mobile device 102 to WAN 106 or WLAN AP 108. In embodiments, mobile device 102 may employ a device centric offloading algorithm or a network centric offloading algorithm for determining whether and when to direct data traffic from mobile device to WAN 106 or WLAN AP 108. For example, in one embodiment, traffic steering module 104 uses various network characteristic information about the cellular WAN and WLAN received at mobile device 102 to determine whether and when to direct data traffic to WAN 106 or WLAN AP 108. In another embodiment, traffic steering module 104 receives steering signals from WAN 106, such as including directions for directing data traffic from mobile device 102 to WAN 106 or WLAN AP 108.

Optionally, network characteristic information of the WLAN is the primary indicator of which route data from mobile device should take. For example, if the network characteristic information indicates that the WLAN is too busy, has low capacity, has little available bandwidth or has high spectral usage, it may be preferable for data from the mobile device to be routed to the cellular WAN. On the other hand, for example, if the network characteristic information indicates that the WLAN is not busy, has high capacity, has high available bandwidth or has low spectral usage, it may be preferable for data from the mobile device to be routed to the WLAN.

Various other characteristics regarding the cellular WAN, WLAN and/or data traffic may be used in determining which route the data traffic should take. For example, Quality of Service characteristics of the data traffic or an application generating the data traffic may identify which route is preferential for the data traffic. In other embodiments, threshold levels may be used for determining which route the data traffic should take, such as threshold levels of one or more network characteristics.

In various embodiments, network characteristics are identified as a network utilization. For example, WLAN utilization may be useful for determining which route data traffic from a mobile device should take. In an exemplary embodiment, WLAN utilization is provided or identified as an Extended BSS load element. As will be understood by the skilled artisan, an Extended BSS load element may be compliant with one or more IEEE 802.11 wireless network specifications, such as 802.11ac, and future 802.11 specifications. Optionally, one or more fields of an Extended BSS load element may be an indicator of WLAN utilization or spectrum utilization.

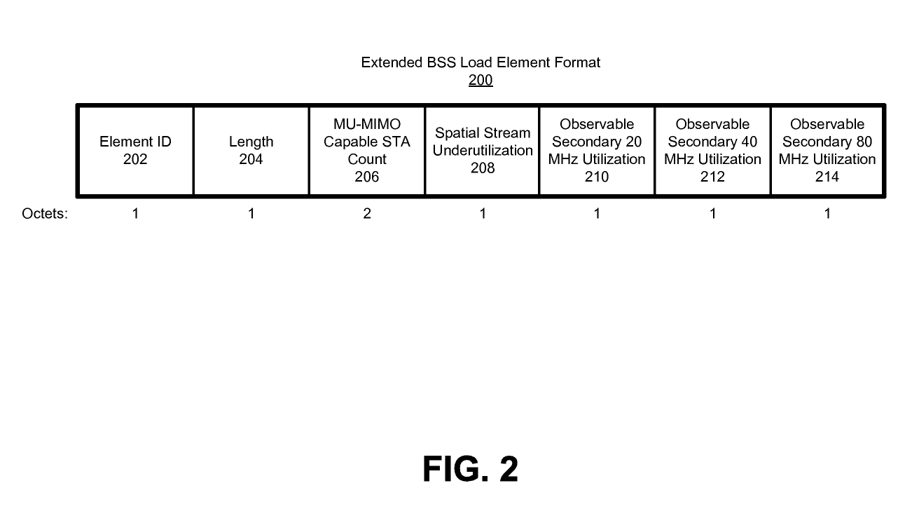

In various embodiments, Extended BSS load elements, or components or fields included in an Extended BSS load element, are transmitted in data packets from a WLAN AP and provide useful information about WLAN characteristics. FIG. 2 provides an overview of the format 200 of an Extended BSS load element, such as may be used with 802.11ac compliant wireless local area networks, and depicts that the various components of the load element include an element ID 202, a length 204, a Multiple User, Multiple Input Multiple Output (MU-MIMO) capable station (STA) count 206, the spatial stream underutilization 208, the observable secondary 20 MHz utilization 210, the observable secondary 40 MHz utilization 212, and the observable secondary 80 MHz utilization 214. The Extended BSS load element measures not only the utilization of the AP's spatial resources on the primary 20 MHz channel, but also the utilization on the secondary 20 MHz, 40 MHz, and 80 MHz channels.

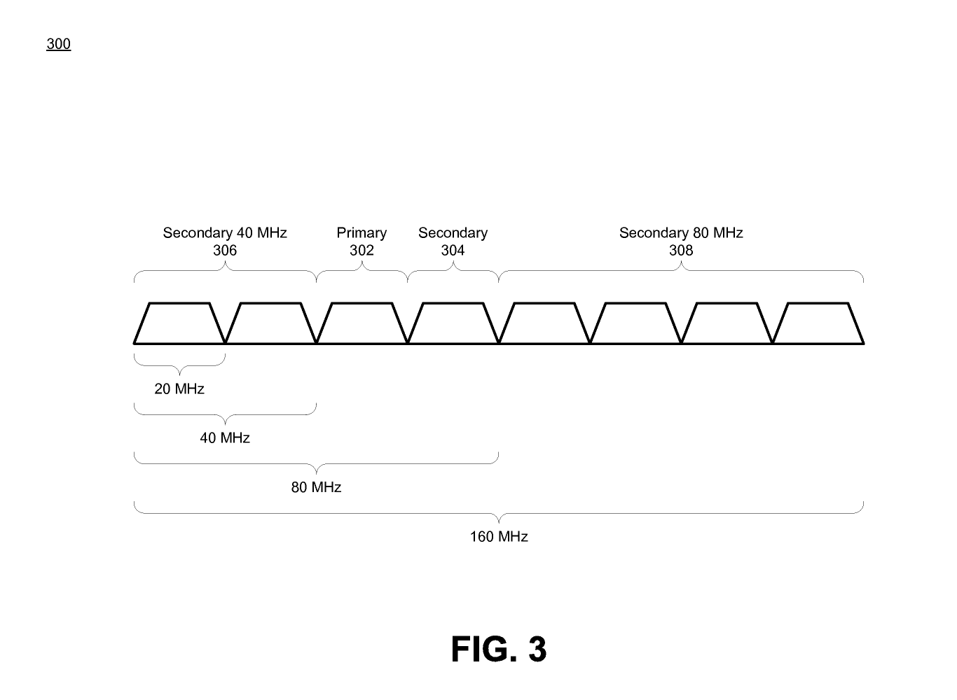

FIG. 3 illustrates channel parameters and identifies an example primary 20 MHz channel 302, a secondary 20 MHz channel 304, a secondary 40 MHz channel 306, and a secondary 80 MHz channel 308. As will be understood by the skilled artisan, the primary 20 MHz channel 302, and secondary 20 MHz channel 304 together comprise the primary 40 MHz channel and the primary 20 MHz channel 302, secondary 20 MHz 304, and secondary 40 MHz channel 306 together comprise the primary 80 MHz channel.

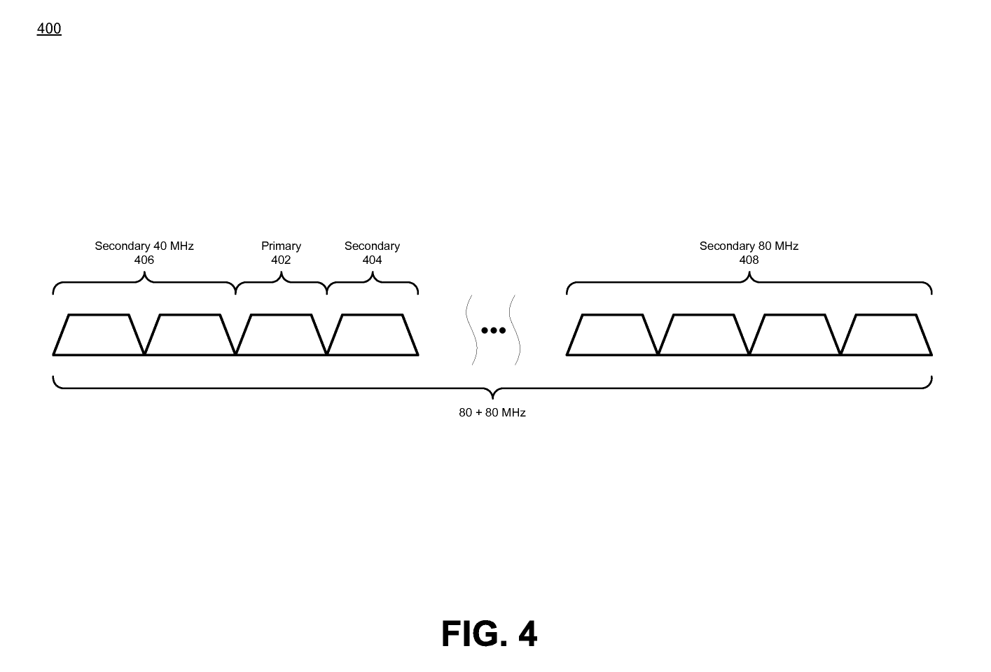

In FIG. 3, the total 160 MHz is shown as a continuous block of channels. In practice, the primary 80 MHz channel and secondary 80 MHz channel need not be continuous. FIG. 4 illustrates a situation where the primary 80 MHz channel and the secondary 80 MHz channel are separated. In FIG. 4. the primary 80 MHz channel is comprised of primary 20 MHz channel 402, secondary 20 MHz channel 404 (which together make up the primary 40 MHz channel), and secondary 40 MHz channel 406, and is separated by some frequency range from secondary 80 MHz channel 408. The skilled artisan will appreciate how airtime is divided up between the various width channels and how various channel access rules apply in an 802.11ac wireless network.

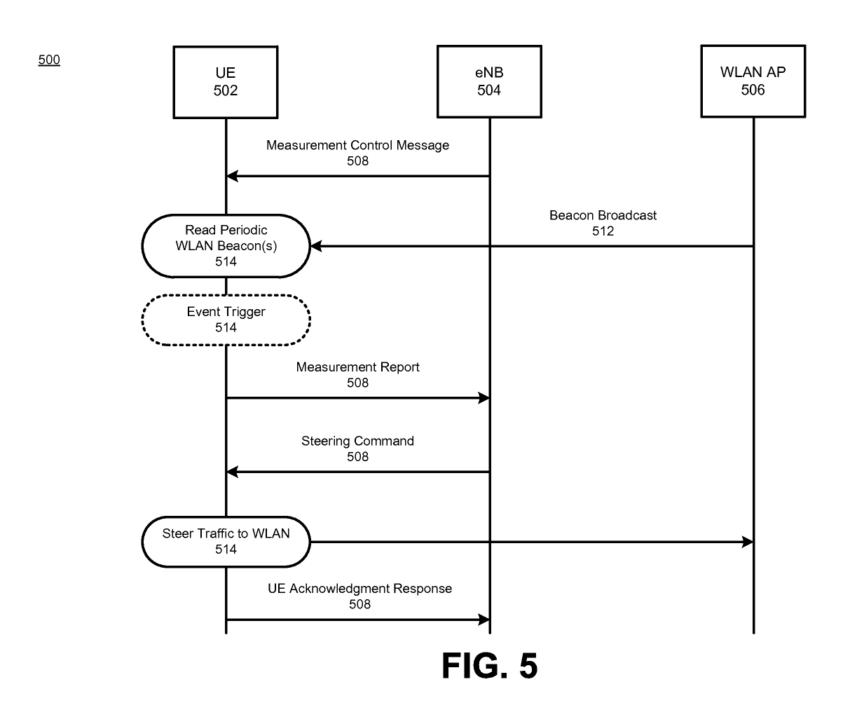

FIGS. 5-9 depict embodiments of various signaling schemes for identifying appropriate instances for offloading or steering data traffic from a mobile device to a WLAN.

In FIG. 5, a measurement control message 508 is transmitted by a cellular WAN, such as Enhanced NodeB (eNB) 504, and received by a mobile device, such as user equipment (UE) 502. In embodiments, the measurement control message 508 direct UE 502 to generate a measurement report 518, for example a single time as a response to a measurement control message and/or periodically upon a preconfigured time period elapsing. Optionally, the measurement control message 508 identifies a target WLAN, such as WLAN AP 506. For example, the WLAN AP 506 may be identified by one or more of operating class, channel number, BSSID, SSID, HESSID, and the like.

Optionally, measurement control message 508 includes threshold information, such as a minimum or maximum spectral utilization for which a measurement report is requested. Optionally, multiple thresholds may be provided, such as one per channel utilization (e.g., primary 20 MHz, secondary 20 Hz, secondary 40 MHz, and secondary 80 MHz). Threshold information is optionally used to request an indication as to whether a specified threshold is exceeded or not (e.g. a false/true or 0/1 indication) or to request information for spectral utilization that falls above the threshold or spectral utilization that falls below the threshold.

Optionally, measurement control message 508 provides threshold information for previous measurements. For example, previous measurement threshold information is optionally provided so that the measurement report may include knowledge of whether the threshold was exceeded for any previous measurement. This information is useful, in embodiments, for example, for determining whether it may be appropriate to steer traffic from UE 502 to WLAN AP 506.

In embodiments, receiving the measurement control message 508 at UE 502 causes UE 502 to identify wireless spectrum utilization. As illustrated, UE receives beacon broadcasts 512 from WLAN AP 706 and reads the periodic WLAN beacons at 514. Information from the periodic WLAN beacons is then used to identify wireless spectrum utilization for generation of measurement report 518.

Optionally, an event trigger 516 indicates when measurement report 518 is to be sent to eNB 504. Event trigger 516 can optionally make use of thresholding as described above. Upon receiving measurement report 508, eNB 504 transmits steering command 502 to UE 502 if WLAN AP 506 has sufficient availability. UE 502 uses steering command 520 to determine that traffic is to be steered to WLAN AP 506. At 522, UE 502 steers traffic to WLAN AP 506. Further, UE 502 optionally transmits an acknowledgement response 524 to eNB 504 in response to steering command 520.

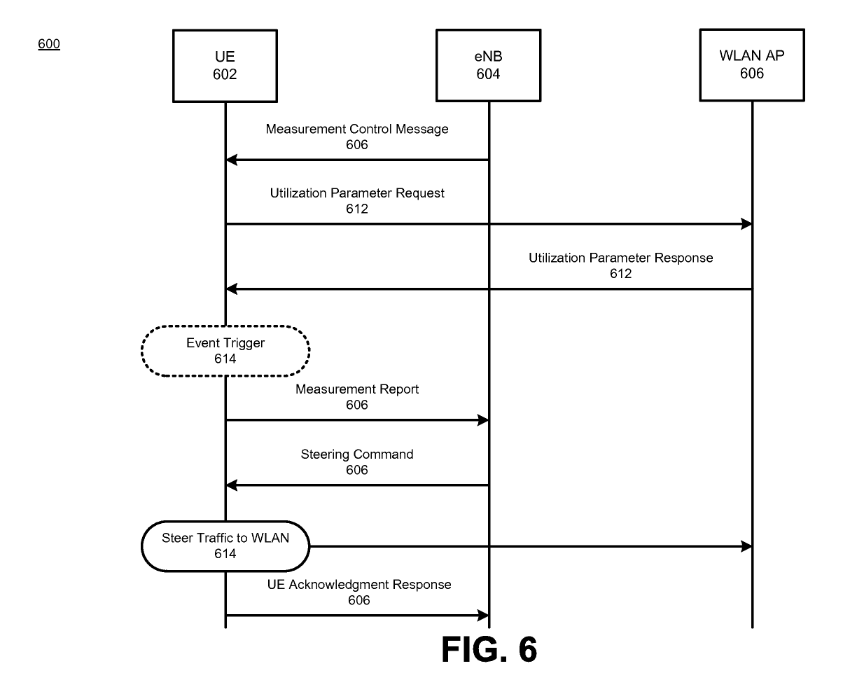

In FIG. 6, a measurement control message 608 is transmitted by a cellular WAN, such as Enhanced NodeB (eNB) 604, and received by a mobile device, such as user equipment (UE) 602. In embodiments, the measurement control message 608 direct UE 602 to generate a measurement report 618, for example a single time as a response to a measurement control message and/or periodically upon a preconfigured time period elapsing. Optionally, the measurement control message 608 identifies a target WLAN, such as WLAN AP 606. For example, the WLAN AP 606 may be identified by one or more of operating class, channel number BSSID, SSID, HESSID, and the like.

Optionally, measurement control message 608 includes threshold information, such as a minimum or maximum spectral utilization for which a measurement report is requested. Optionally, multiple thresholds may be provided, such as one per channel utilization (e.g., primary 20 MHz, secondary 20 Hz, secondary 40 MHz, and secondary 80 MHz). Threshold information is optionally used to request an indication as to whether a specified threshold is exceeded or not (e.g. a false/true or 0/1 indication) or to request information for spectral utilization that falls above the threshold or spectral utilization that falls below the threshold.

Optionally, measurement control message 608 provides threshold information for previous measurements. For example, previous measurement threshold information is optionally provided so that the measurement report may include knowledge of whether the threshold was exceeded for any previous measurement. This information is useful, in embodiments, for example, for determining whether it may be appropriate to steer traffic from UE 602 to WLAN AP 606.

In embodiments, receiving the measurement control message 608 at UE 602 causes UE 602 to transmit a utilization parameter request 610. In response, WLAN AP 606 transmits a utilization parameter response 612 that identifies wireless spectrum utilization. The wireless spectrum utilization information is then used for generation of measurement report 618.

Optionally, an event trigger 616 indicates when measurement report 618 is to be sent to eNB 604. Event trigger 616 can optionally make use of thresholding as described above. Upon receiving measurement report 608, eNB 604 transmits steering command 620 to UE 602 if WLAN AP 606 has sufficient availability. UE 602 uses steering command 620 to determine that traffic is to be steered to WLAN AP 606. At 622, UE 602 steers traffic to WLAN AP 606. Further, UE 602 optionally transmits an acknowledgement response 624 to eNB 604 in response to steering command 620.

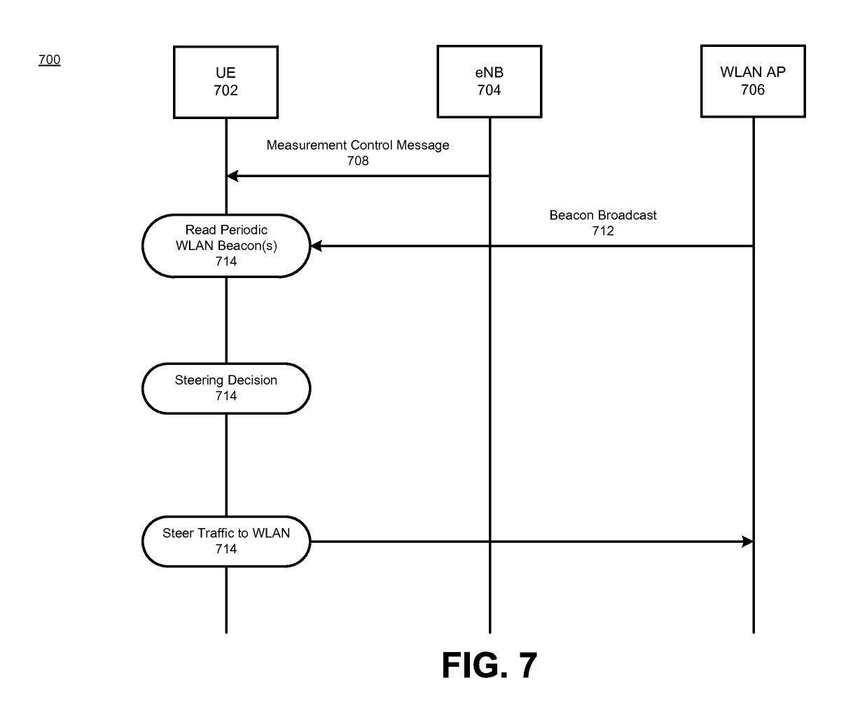

In FIG. 7, a measurement control message 708 is transmitted by a cellular WAN, such as Enhanced NodeB (eNB) 704, and received by a mobile device, such as user equipment (UE) 702. Optionally, the measurement control message 708 identifies a target WLAN, such as WLAN AP 706. For example, the WLAN AP 706 may be identified by one or more of operating class, channel number BSSID, SSID, HESSID, and the like. In embodiments, the measurement control message 708 direct UE 702 to self-determine when to steer traffic to WLAN AP 706. In embodiments, receiving the measurement control message 708 at UE 702 causes UE 702 to identify wireless spectrum utilization. As illustrated, UE receives beacon broadcasts 712 from WLAN AP 706 and reads the periodic WLAN Beacons at 714, such as may include an element describing spectrum utilization. Information from the periodic WLAN beacons is then used to identify wireless spectrum utilization for generation of measurement report 718.

Optionally, measurement control message 708 includes threshold information, such as a minimum or maximum spectral utilization for which steering traffic from UE 702 to WLAN AP 706 may be appropriate. Optionally, multiple thresholds may be provided, such as one per channel utilization (e.g., primary 20 MHz, secondary 20 Hz, secondary 40 MHz, and secondary 80 MHz).

Optionally, measurement control message 708 provides threshold information for previous measurements. For example, previous measurement threshold information is optionally provided so that UE 702 can utilize information regarding whether the threshold was exceeded for any previous measurement in determining whether it may be appropriate to steer traffic from UE 702 to WLAN AP 706.

Upon determining that WLAN AP 706 has sufficient availability, UE 702 makes a steering decision 720 to determine that traffic is to be steered to WLAN AP 706. Steering decision 720 may optionally make use of thresholding, as described above. At 722, UE 702 steers traffic to WLAN AP 706.

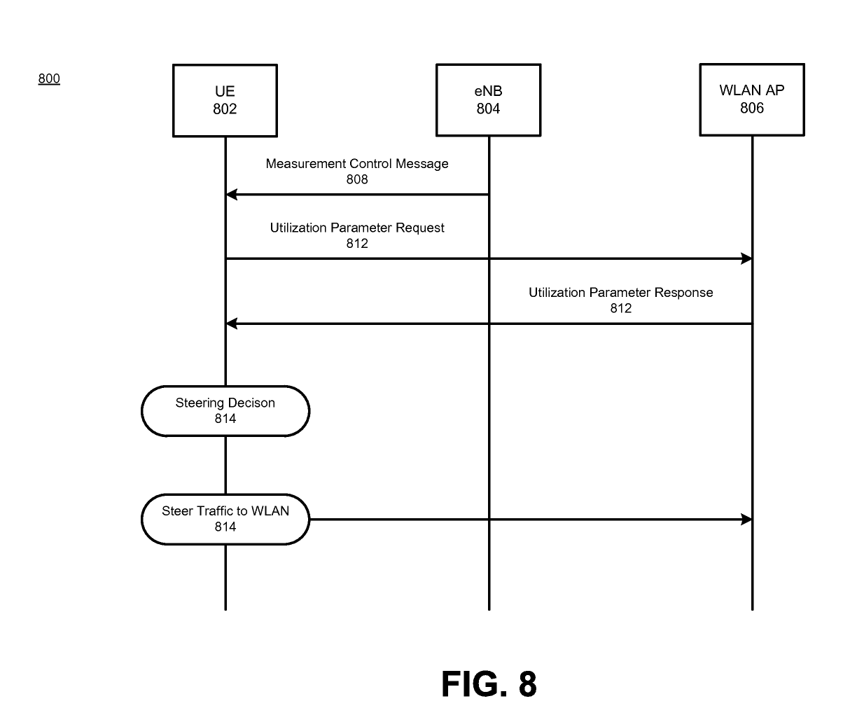

In FIG. 8, a measurement control message 808 is transmitted by a cellular WAN, such as Enhanced NodeB (eNB) 804, and received by a mobile device, such as user equipment (UE) 802. Optionally, the measurement control message 808 identifies a target WLAN, such as WLAN AP 806. For example, the WLAN AP 606 may be identified by one or more of operating class, channel number BSSID, SSID, HESSID, and the like. In embodiments, the measurement control message 808 direct UE 802 to self-determine when to steer traffic to WLAN AP 806. In embodiments, receiving the measurement control message 808 at UE 802 causes UE 802 to transmit a utilization parameter request 810. In response, WLAN AP 806 transmits a utilization parameter response 812 that identifies wireless spectrum utilization.

Optionally, measurement control message 808 includes threshold information, such as a minimum or maximum spectral utilization for which steering traffic from UE 802 to WLAN AP 806 may be appropriate. Optionally, multiple thresholds may be provided, such as one per channel utilization (e.g., primary 20 MHz, secondary 20 Hz, secondary 40 MHz, and secondary 80 MHz).

Optionally, measurement control message 808 provides threshold information for previous measurements. For example, previous measurement threshold information is optionally provided so that UE 802 can utilize information regarding whether the threshold was exceeded for any previous measurement in determining whether it may be appropriate to steer traffic from UE 802 to WLAN AP 806.

Upon determining that WLAN AP 806 has sufficient availability, such as based on the received utilization parameter response 812, UE 802 makes a steering decision 820 to determine that traffic is to be steered to WLAN AP 806. Steering decision 820 may optionally make use of thresholding, as described above. At 822, UE 802 steers traffic to WLAN AP 806.

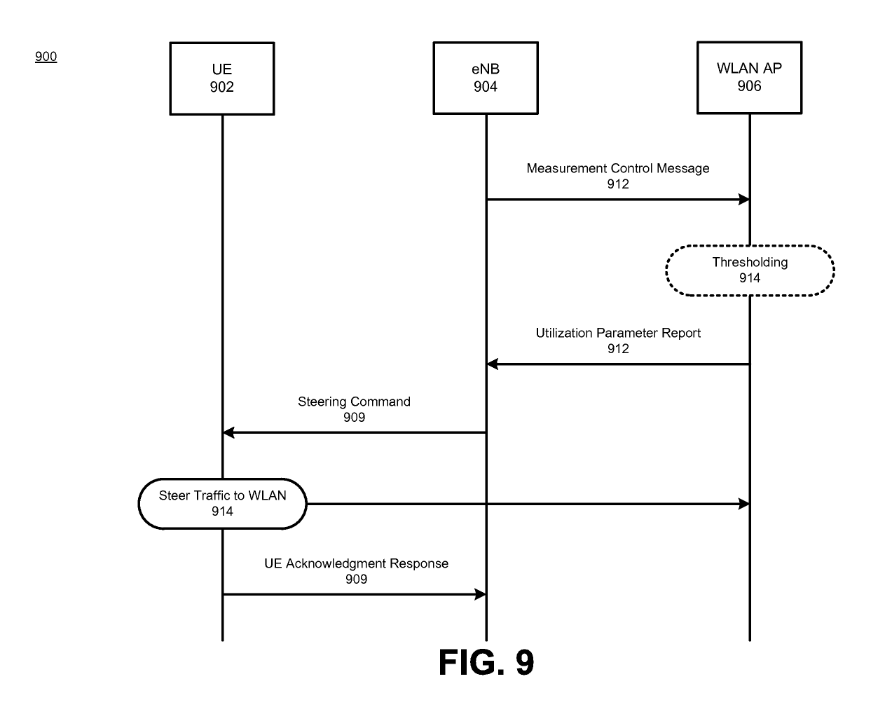

In FIG. 9, a measurement control message 908 is transmitted by a cellular WAN, such as Enhanced NodeB (eNB) 904, and received by a WLAN AP, such as WLAN AP 906. The measurement control message 908 may include a utilization parameter request. Optionally, at 910, threshold levels may be determined and upon determining that WLAN 906 has sufficient availability or the spectrum utilization is below a specified threshold, WLAN AP 906 may transmit a utilization parameter report 912. If thresholding is not applied, the WLAN AP 906 transmits the utilization parameter report 912, which is received by eNB 904.

eNB 904 may then use the utilization parameter report 912 to determine if WLAN AP has sufficient availability. Upon such a determination, eNB 904 transmits steering command 920 to a mobile device, such as UE 902. UE 902 uses steering command 920 to determine that traffic is to be steered to WLAN AP 906. At 922, UE 902 steers traffic to WLAN AP 906. Further, UE 902 optionally transmits an acknowledgement response 924 to eNB 904 in response to steering command 920.

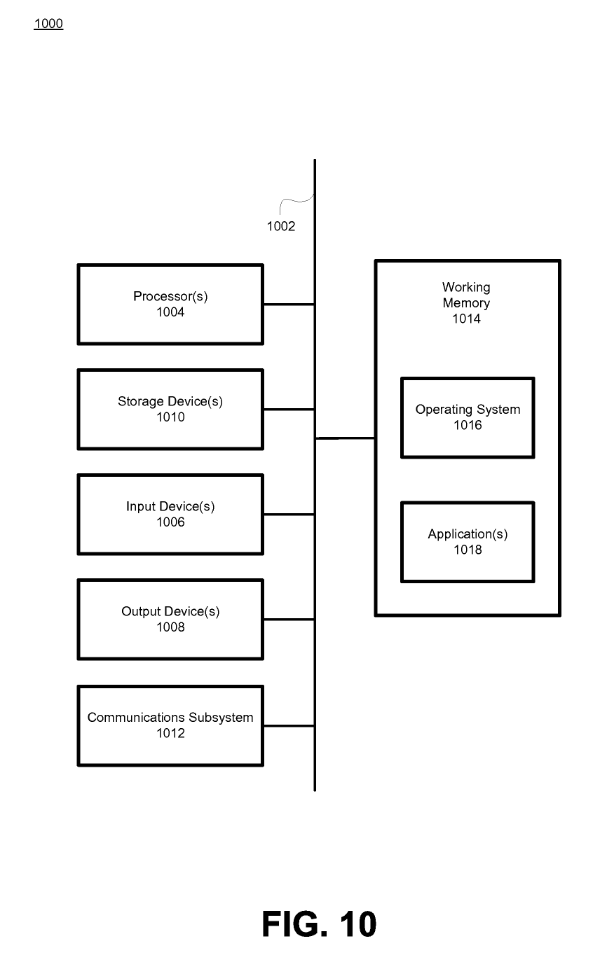

Systems, methods, devices, and computer-program products are contemplated to implement the features or aspects of the present disclosure. FIG. 10 shows an example computer system or device 1000 in accordance with the disclosure.

The computer device 1000 is shown comprising hardware elements that may be electrically coupled via a bus 1002 (or may otherwise be in communication, as appropriate). The hardware elements may include a processing unit with one or more processors 1004, including without limitation one or more general-purpose processors and/or one or more special-purpose processors (such as digital signal processing chips, graphics acceleration processors, and/or the like); one or more input devices 1006, and one or more output devices 1008.

The computer system 1000 may further include (and/or be in communication with) one or more non-transitory storage devices 1010, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 1000 might also include a communications subsystem 1012, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM, W-CDMA, LTE, etc. The communications subsystem 1012 may permit data to be exchanged with a network (such as the network described below, to name one example), other computer systems, and/or any other devices described herein. In many examples, the computer system 1000 will further comprise a working memory 1014, which may include a random access memory and/or a read-only memory device, as described above.

The computer device 1000 also may comprise software elements, shown as being currently located within the working memory 1014, including an operating system 1016, device drivers, executable libraries, and/or other code, such as one or more application programs 1018, which may comprise computer programs provided by various examples, and/or may be designed to implement methods, and/or configure systems, provided by other examples, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 1010 described above. In some cases, the storage medium might be incorporated within a computer system, such as computer system 1000. In other examples, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some examples may employ a computer system (such as the computer device 1000) to perform methods in accordance with various examples of the disclosure. According to a set of examples, some or all of the procedures of such methods are performed by the computer system 1000 in response to processor 1004 executing one or more sequences of one or more instructions (which might be incorporated into the operating system 1016 and/or other code, such as an application program 1018) contained in the working memory 914. Such instructions may be read into the working memory 1014 from another computer-readable medium, such as one or more of the storage device(s) 1010. Merely by way of example, execution of the sequences of instructions contained in the working memory 1014 may cause the processor(s) 1004 to perform one or more procedures of the methods described herein.

The terms “machine-readable medium” and “computer-readable medium,” as used herein, may refer to any non-transitory medium that participates in providing data that causes a machine to operate in a specific fashion. In an example implemented using the computer device 1000, various computer-readable media might be involved in providing instructions/code to processor(s) 1004 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 1010. Volatile media may include, without limitation, dynamic memory, such as the working memory 1014.

Example forms of physical and/or tangible computer-readable media may include a floppy disk, a flexible disk, hard disk, magnetic tape, or any other magnetic medium, a compact disc, any other optical medium, ROM, RAM, and etc., any other memory chip or cartridge, or any other medium from which a computer may read instructions and/or code. Various forms of computer-readable media may be involved in carrying one or more sequences of one or more instructions to the processor(s) 1004 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1012 (and/or components thereof) generally will receive signals, and the bus 1002 then might carry the signals (and/or the data, instructions, etc., carried by the signals) to the working memory 1014, from which the processor(s) 1004 retrieves and executes the instructions. The instructions received by the working memory 1014 may optionally be stored on a non-transitory storage device 1010 either before or after execution by the processor(s) 1004. It should further be understood that the components of computer device 1000 can be distributed across a network. For example, some processing may be performed in one location using a first processor while other processing may be performed by another processor remote from the first processor. Other components of computer system 900 may be similarly distributed. As such, computer device 1000 may be interpreted as a distributed computing system that performs processing in multiple locations. In some instances, computer system 1000 may be interpreted as a single computing device, such as a distinct laptop, desktop computer, or the like, depending on the context.

The features or aspects of the present disclosure discussed above are examples. Various configurations may omit, substitute, or add various method steps or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

The following list of acronyms that may be used herein are provided for the convenience of the reader:

3GPP—3^{rd} Generation Partnership Project

AP—Access Point

BSS—Basic Service Set

BSSID—Basic Service Set Identifier

(e)NB or eNB—(enhanced) Node B

HESSID—Homogeneous Extended Service Set Identifier

LTE—Long Term Evolution

SSID—Service Set Identifier

STA—Station

UE—User Equipment

WAN—Wide Area Network

WLAN—Wireless Local Area Network

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Aspects of the invention may be further understood by reference to the following non-limiting examples:

### EXAMPLES

3GPP has a work item on 3GPP-WLAN interworking enhancement. One aspect of the work item is traffic offloading, where some part or all of the traffic is offloaded from a 3GPP network to a WLAN. Another aspect could be handover, i.e., the case where the UE is completely moved to the WLAN. The purpose of the offloading/handover is to improve service for the subscriber and hence the 3GPP network needs to obtain as much accurate information as possible in order to improve the user data rate, latency, and etc. When an offloading/handover decision is being done, the UE is already accessing the 3GPP network and hence the situation in the network is already known. However, since the user has not yet accessed the WLAN network an estimate on the WLAN performance should be obtained. Aspects affecting WLAN performance include, for example, radio conditions for the UE, bandwidth, and load of the WLAN BSS. The present disclosure is directed to obtaining an estimate of WLAN BSS Load for 802.11 ac by measuring different channel utilizations at the AP. It is contemplated that the features or aspects of the present disclosure be applied at least to both WCDMA and LTE systems, and possibly other systems as well as technology evolves, as a means of or for enhancing 3GPP/non-3GPP interworking

The Extended BSS load element is shown in FIG. 2. The Extended BSS load element measures not only the utilization of the AP's spatial resources on the primary 20 MHz channel, but also the utilization on the secondary 20 MHz, 40 MHz, and 80 MHz channels.

MU-MIMO Capable STA Count: Number of STAs associated with BSS that have enabled their MU Beamformee Capable field in their VHT (Very High Throughput) Capabilities element.

Spatial Stream Underutilization: Percentage of time that the AP has underutilized spatial domain resources on the primary channel for a given busy time of the medium. Percentage is linearly scaled with 255 representing 100%. It is given by the formula:

$$Spatial Stream Underutilization = ⌊ \frac{{N}_{max \_ SS} \times {T}_{busy} - {T}_{utilized}}{{N}_{max \_ SS} \times {T}_{busy}} \times 255 ⌋$$

Nₘₐₓ_{_}_{SS}: Maximum number of spatial streams that the AP supports

T_{busy}: Time in us that the CCA has sensed the channel to be busy during a measurement period. If it equals 0 then the Spatial Stream Underutilization field is reserved.

T_{utilized}=Σᵢ₌₁^{N}N_{SS,i}Tᵢ:Tᵢ is the time in us that the primary 20 MHz channel is busy due to transmissions to MU-capable STAs,

N_{SS,i} is the number of spatial streams transmitted in Tᵢ and N is the number of busy events that occurred during the measurement period.

The fields Observable Secondary 20 MHz Utilization, Observable Secondary 40 MHz Utilization, Observable Secondary 80 MHz Utilization are given by the following general formula:

$$Observable Secondary W 1 Utilization = ⌊ \frac{{T}_{busy , W 1}}{\begin{matrix}dot 11 ChannelUtilizationBeaconIntervals \times \\ dot 11 BeaconPeriod \times 1024\end{matrix}} \times 255 ⌋$$

dot11ChannelUtilizationBeaconIntervals is the number of (consecutive) Beacon intervals over which the secondary channel busy time is measured,

dot11BeaconPeriod is the period (in TUs) with which Beacon frames are generated

T_{busy,W1} is the sum of times from the PHY-CCA.indication(BUSY, {W2}), where W2 stands for the secondary 20 MHz, 40 MHz or 80 MHz channel to the next issue of PHY-CCA indication that overlaps the measurement interval for W1=20, 40, or 80.

802.11ac allows transmissions on primary and secondary channels. The channel list parameter elements include the following:

a) primary: For a VHT STA it indicates that the 20 MHz primary channel is busy according to channel access rules,

b) secondary: For a VHT STA it indicates that the 20 MHz secondary channel is busy according to the channel access rules,

c) secondary40: For a VHT STA it indicates that the 40 MHz secondary channel is busy according to the channel access rules,

d) secondary80: For a VHT STA it indicates that the 80 MHz secondary channel is busy according to the channel access rules,

Some examples of the parameters described in a)-d) are shown in FIG. 3 and FIG. 4.

As mentioned above, the present disclosure is directed to 3GPP/non-3GPP interworking. More specifically, it is contemplated that an estimate of the WLAN BSS load may be obtained by using the Enhanced BSS Load feature specified in 802.11ac, and used as a measure on the performance of the WLAN in order to decide whether to offload to the WLAN or not.

In one example, an (e)NB sends a request for a measurement (e.g., measurement control message as illustrated in the accompanying figures) of the Extended BSS load with parameters to one or more WLANs. These WLANs can be specified by e.g., including in the request their corresponding BSSID(s)/SSID(s)/HESSID(s) or other identifiers.

The request may be explicit or implicit. For example, an explicit request may request the Extended BSS load parameter element. For example, an implicit request may request parameters regarding channel (under)utilizations (e.g., on the primary, or on the secondary 20 MHz, secondary 40 MHz, secondary 80 MHz channels). Optionally, utilizations of other channel bandwidth can be requested also (e.g., for 802.11 amendments utilizing other frequencies)

In various embodiments, the request may be received by a WLAN AP or by a UE. For example, if there is an interface between the (e)NB and a WLAN AP then the request will be received by the AP. Optionally, in the absence of an interface the request will be received by a UE. Optionally, a UE may or may not be connected to the WLAN AP to receive the message.

In another example, the requested parameters, requested through explicit or implicit requests, are sent to the (e)NB. For example, those parameters may be sent by an AP or a UE. Optionally, if a UE is not connected to the WLAN network then it can send the measurement through a signaling message in 3GPP network.

Optionally, a UE upon reception of a measurement request sends a subsequent request to the AP to claim these parameters For example, a UE may send a Probe Request message to the AP using BSSID(s)/SSID(s)/HESSID(s) or other identifiers specified by (e)NB. The AP may respond with a Probe Response, containing the Extended BSS load parameter element.

Alternatively, a UE upon reception of a measurement request receives parameters broadcasted by the AP. For example, a UE may receive from the AP with BSSID(s)/SSID(s)/HESSID(s) or other identifiers specified by (e)NB a beacon transmission containing the Extended BSS load parameter element.

If available, an AP can optionally send the measurements to the (e)NB through a common interface. For example, the ID of the WLAN is sent along with the parameters (e.g., the BSSID(s)/SSID(s)/HESSID(s) or other identifiers). This is especially beneficial when more than one WLAN APs have been requested measurements.

Further, it is contemplated that the parameters (Spatial Stream Underutilization, Observable Secondary 20 MHz Utilization, Observable Secondary 40 MHz Utilization, and Observable Secondary 80 MHz Utilization) may be thresholded at the AP or at the UE before a message is sent regarding the AP in question.

In embodiments, the decision maker (AP or UE) can have different threshold values. These threshold values may be given to a) the AP by the (e)NB or any other element in 3GPP network and to b) the UE by the AP or the (e)NB or any other element in 3GPP network. For example, multiple thresholds may be provided, one per channel utilization (e.g., threshold_primary, threshold_secondary, threshold_secondary40, threshold_secondary80). Alternatively, a single threshold value may be used.

In some embodiments, the message may indicate whether the AP in measurement passes the quality threshold. For example, it may be indicated with a 1 if it passes the quality threshold and with a 0 if it does not pass. Alternatively, the message may only report the utilization measurements. For example, the message may list all the measured parameters. Optionally, the message may list the measurement parameters only for APs passing the quality threshold.

In another example, the (e)NB, upon receiving the message from the AP(s) or UE, decides to offload a user or some of the user data to one of those APs. For example, The BSSID(s)/SSID(s)/HESSID(s) or other identifiers of the WLAN may be included in the offloading command message. Optionally, the offloading command message is sent to the UE to signal it to associate with the selected AP. For example, the UE sends an Association Request message to the WLAN with the signaled BSSID(s)/SSID(s)/HESSID(s) or other identifiers.

In another example, the UE, upon receiving the request for measurement message from the (e)NB, decides to offload a user or some of the user data based on the information in request message UE sends an Association Request message to the WLAN with the signaled BSSID(s)/SSID(s)/HESSID(s) or other identifiers.

Some signaling examples are given in FIG. 5 through FIG. 9.

### Example A

### Signaling for Network Centric Offloading Using Utilization Information Signaled in Beacon Frames

FIG. 5 shows signaling for network centric offloading using broadcasted utilization information. It is contemplated that the signaling procedure may include or comprise the following steps:
1. Measurement control: Message can be for example a measurement request message. It contains control information required to do the measurements, e.g. SSID, BSSID, HESSID, thresholds etc.
2. Read broadcasted information, e.g. periodic WLAN beacon(s). Beacon contains also Extended BSS load element.
3. Event trigger: Event trigger can be used for event triggered reporting. This step is optional and not needed e.g. in case periodic reporting is used.
4. Measurement report: Measurement report containing parameters is signaled to (e)NB.
5. Steering command: When offloading decision is done by the (e)NB, it signals a steering command to UE.
6. Steer traffic to WLAN: User or some of the user data is offloaded to WLAN.
7. UE ACK response: UE sends acknowledgement to steering command.

Receiving beacon(s) takes some time so the UE e.g. may be pre-configured to search for appropriate AP(s) and when found send the report to the network. The network can then use the reported information whenever there is a need for offloading.

### Example B

### Signaling for Network Centric Offloading Using Requested Utilization Information

FIG. 6 shows signaling for network centric offloading using requested utilization information. It is contemplated that the signaling procedure may include or comprise the following steps:
1. Measurement control: Message can be for example a measurement request message. Message contains control information required to do the measurements, e.g. SSID, BSSID, HESSID, thresholds etc.
2. Utilization parameter request: UE requests utilization parameters from AP. This can be done for example through a Probe Request message from the UE to the AP.
3. Utilization parameter report: AP responds with utilization parameter report. This can be done for example through a Probe Response message from the AP to the UE.
4. Event trigger: Event trigger can be used for event triggered reporting. This step is optional and not needed e.g. in case periodic reporting is used.
5. Measurement report: Measurement report containing parameters is signaled to (e)NB.
6. Steering command: When offloading decision is done by the (e)NB, it signals a steering command to UE.
7. Steer traffic to WLAN: User or some of the user data is offloaded to WLAN.
8. UE ACK response: UE sends acknowledgement to steering command.

### Example C

### Signaling for UE Centric Offloading Using Utilization Information Signaled in Beacon

FIG. 7 shows signaling for UE centric offloading using broadcasted utilization information It is contemplated that the signaling procedure may include or comprise the following steps:
1. Measurement control: Message can be for example a measurement request message. Message contains control information required to do the measurements, e.g. SSID, BSSID, HESSID, thresholds etc.
2. Measurement thresholds: This message is shown to emphasize that decision thresholds are signaled to the UE, which is the entity that makes the final decision in UE centric offloading.
3. Read broadcasted information, e.g. periodic WLAN beacon(s). Beacon contains also Extended BSS load element.
4. Steering decision: UE makes the final decision to offload.
5. Steer traffic to WLAN: User or some of the user data is offloaded to WLAN.

Receiving beacon(s) takes some time so the UE e.g. may be pre-configured to search for appropriate AP(s) and when found send the report to the network. The network can then use the reported information whenever there is a need for offloading.

### Example D

### Signaling for UE Centric Offloading Using Requested Utilization Information

FIG. 8 shows signaling for UE centric offloading using requested utilization information. It is contemplated that the signaling procedure may include or comprise the following steps:
1. Measurement control: Message can be for example a measurement request message. Message contains control information required to do the measurements, e.g. SSID, BSSID, HESSID, thresholds etc.
2. Measurement thresholds: This message is shown to emphasize that decision thresholds are signaled to the UE, which is the entity that makes the final decision in UE centric offloading.
3. Utilization parameter request: UE requests utilization parameters from AP. This can be done for example through a Probe Request message from the UE to the AP.
4. Utilization parameter report: AP responds with utilization parameter report. This can be done for example through a Probe Response message from the AP to the UE.
5. Steering decision: UE makes the final decision to offload.
6. Steer traffic to WLAN: User or some of the user data is offloaded to WLAN.

### Example E

### Signaling for Network Centric Offloading with Network Signaling

FIG. 9 shows signaling for network centric offloading with network signaling. It is contemplated that the signaling procedure may include or comprise the following steps:
1. Utilization parameter request: (e)NB requests utilization parameters from AP.
2. Thresholding: AP may threshold the utilization parameters. This step is optional.
3. Utilization parameter report: AP responds with utilization parameter report.
4. Steering command: When an offloading decision is taken by the (e)NB, it signals steering command to UE.
5. Steer traffic to WLAN: User or some of the user data is offloaded to WLAN.
6. UE ACK response: UE sends acknowledgement to steering command.

BSS Load Element cannot capture the utilization of the secondary channels that the AP may use. Also it cannot capture the case where an AP has underutilized resources in the spatial domain. If the primary 20 MHz channel has a low utilization but the secondary channels are mostly busy then the AP does not have the opportunity to use wider bandwidths and will be inferior to a different AP with low utilization in both primary and secondary channels. However, the advantages provided by the features or aspects of the present disclosure are or relate to signaling the Extended BSS load element that has been introduced in the Beacon and Probe Response frames of 802.11ac to the (e)NB for WLAN selection. The Extended BSS load Element is an enhanced version of the BSS Load element in the sense that it also captures the utilization of the secondary channels and spatial streams.

The features or aspects of the present disclosure discussed above are examples. Various configurations may omit, substitute, or add various method steps or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

What is claimed is:

1. A device configured to selectively route mobile device traffic to a wireless local area network (WLAN), comprising:
a cellular wide area network (WAN) transceiver for communicating with a cellular WAN;
a WLAN transceiver for communicating with a WLAN;
a processor; and
a memory element coupled with and readable by the processor and having stored therein processor-readable instructions that when executed by the processor, cause the processor to perform operations comprising:
receiving a measurement control message from the cellular WAN, wherein the measurement control message identifies a target WLAN;
identifying wireless spectrum utilization for the target WLAN; and
determining that traffic of a mobile device is to be routed to the target WLAN based on the identified wireless spectrum utilization.

2. The device of claim 1, wherein the device comprises a mobile device and wherein the measurement control message is received at a transceiver of the mobile device; or wherein the device comprises a wireless access point of the target WLAN and wherein the measurement control message is received at a transceiver of the wireless access point.

3. The device of claim 1, wherein the measurement control message includes one or more network identifiers for identifying the target WLAN.

4. The device of claim 1, wherein the measurement control message includes a request for wireless spectrum utilization for the target WLAN.

5. The device of claim 1, wherein identifying wireless spectrum utilization for the target WLAN comprises:
receiving one or more beacon frames from the target WLAN, wherein at least one beacon frame includes an Extended Basic Service Set load element.

6. The device of claim 1, wherein identifying wireless spectrum utilization for the target WLAN comprises:
transmitting a request for wireless spectrum utilization parameters to the target WLAN; and
receiving a response from the target WLAN providing the wireless spectrum utilization parameters.

7. The device of claim 6, wherein the request comprises a wireless probe request, and wherein the response includes an Extended Basic Service Set (Extended BSS) load element or one or more fields of an Extended BSS load element.

8. The device of claim 1, wherein identifying wireless spectrum utilization for the target WLAN comprises identifying one or more of a WLAN Multiple User-Multiple Input Multiple Output (MU-MIMO) station count, a WLAN spatial stream underutilization, a WLAN observable primary channel utilization, and a WLAN observable secondary channel utilization.

9. The device of claim 6, wherein the request comprises a request for WLAN channel utilization.

10. The device of claim 1, wherein identifying wireless spectrum utilization for the target WLAN comprises:
receiving a measurement report including the wireless spectrum utilization for the target WLAN.

11. The device of claim 1, wherein identifying wireless spectrum utilization for the target WLAN comprises:
monitoring network communications on one or more wireless channels used by the target WLAN; and
computing wireless spectrum utilization based on the monitored network communications.

12. The device of claim 1, wherein determining that traffic of the mobile device is to be routed to the target WLAN comprises:
transmitting a measurement report to the cellular WAN, wherein the measurement report includes the identified wireless spectrum utilization for the target WLAN; and
receiving a steering command from the cellular WAN, wherein the steering command indicates that at least a portion of traffic of the mobile device is to be routed to the target WLAN.

13. The device of claim 1, wherein determining that traffic of the mobile device is to be routed to the target WLAN comprises:
analyzing the identified wireless spectrum utilization; and
determining that the target WLAN possesses sufficient capacity for receiving at least a portion of the traffic of the mobile device.

14. The device of claim 1, wherein determining that traffic of the mobile device is to be routed to the target WLAN comprises:
transmitting an association request message to the target WLAN; and
establishing a WLAN connection with the target WLAN.

15. The device of claim 1, wherein the measurement control message includes a measurement threshold, wherein the measurement threshold identifies a target wireless spectrum utilization value sufficient for offloading traffic of the mobile device to the target WLAN.

16. The device of claim 15, wherein determining that traffic of the mobile device is to be routed to the target WLAN comprises:
comparing the identified wireless spectrum utilization with the measurement threshold; and
determining that the target WLAN possesses sufficient capacity for receiving at least a portion of the traffic of the mobile device based on the comparison.

17. The device of claim 1, wherein the operations further comprise:
routing a portion of the traffic of the mobile device to the target WLAN.

18. The device of claim 1, wherein the operations further comprise:
routing all of the traffic of the mobile device to the target WLAN.

19. The device of claim 1, wherein the operations further comprise:
negotiating a handover of the mobile device from the cellular WAN to the target WLAN.

20. The device of claim 1, wherein the target WLAN comprises an Institute of Electrical and Electronics Engineers (IEEE) 802.11 ac compliant WLAN, wherein the measurement control message includes a service set identifier for the target WLAN, and wherein the cellular WAN comprises a long-term evolution (LTE) compliant WAN.

21. A method for selectively routing mobile device traffic to a wireless local area network (WLAN), comprising:
receiving a measurement control message from a cellular wide area network (WAN), wherein the measurement control message identifies a target WLAN;
identifying wireless spectrum utilization for the target WLAN; and
determining that traffic of a mobile device is to be routed to the target WLAN based on the identified wireless spectrum utilization.

22. A non-transitory computer-readable medium having stored therein processor-readable instructions that, when executed by a processor, cause the processor to perform operations comprising:
receiving a measurement control message from a cellular wide area network (WAN), wherein the measurement control message identifies a target wireless local area network (WLAN);
identifying wireless spectrum utilization for the target WLAN; and
determining that traffic of a mobile device is to be routed to the target WLAN based on the identified wireless spectrum utilization.
